(19) United States
(12) Patent Application Publication
(10) Pub. No.: US 2007/0042810 A1
(43) Pub. Date: Feb. 22, 2007

(54) Earphone jack signal line

(75) Inventor: Tonny Chen, Changhua (TW)

Correspondence Address: BRUCE H. TROXELL;SUITE 1404, 5205 LEESBURG PIKE, FALLS CHURCH, VA, 22041, US

(73) Assignee: E-Lead Electronic Co., Ltd

(21) Appl. No.: 11/205,102

(22) Filed: Aug. 17, 2005

(51) Int. Cl. H04M 1/00

(52) U.S. Cl. 455/569.1

(57) ABSTRACT

An earphone jack signal line includes a conductive wire which has a first connector on one end and a second connector on other end. The first connector is inserted into an earphone jack of a mobile phone. The second connector is connected to a handsfree. The signal line includes at least an earphone circuit and a mike circuit, and a call detection unit to activate operation of the handsfree. The earphone jack signal line thus formed can improve compatibility and reduce production cost.

### BACKGROUND OF THE INVENTION

1. Field of the Invention

The invention relates to an earphone jack signal line and particularly to a signal line to connect an earphone jack of a mobile phone to a handsfree to improve compatibility of the signal line and reduce production cost.

2. Description of the Prior Art

The conventional handsfrees now on the market as the one shown in FIG. 1 generally include a handsfree 1 and a mating signal line 2. The signal line 2 has a first connector 21 on one end to be connected to the handsfree 1 and a second connector 22 on other end corresponding to a phone jack of a mobile phone. When a user changes a mobile phone, a new signal line 2 mating the new mobile phone is acquired but the old handsfree can still be used.

While the conventional method mentioned above can solve the compatibility problem of the handsfree by replacing the signal line, the signal line has to receive required signals from the phone jack through a dedicated connector. The signals include sound signals, calling notice signals and the like. The mobile phones of the same brand might share a few common signal lines. But in most occasions one type of mobile phone has one mating and dedicated signal line. As there are a wide variety of mobile phones on the market, and they are obsolete very quickly, the conventional signal lines have disadvantages, notably:
1. The product life cycle of mobile phones is very short, developing dedicated signal lines with a special connector is more difficult and takes longer time. It could happen that after a new signal line is developed and introduced, the mating mobile phone has already been withdrawn from the market. Hence consumers cannot fully enjoy the benefit of handsfree when replacing the mobile phone, and have to procure a new vehicle handsfree. It is a waste of investment.
2. As the types and models of mobile phones are numerous, many different types of mating and dedicated signal lines also have to be developed and produced to meet market requirements. The costs of development and inventory of manufacturers are higher. Signal line vendors also have to stock many types of signal lines to meet market requirements. Once the mobile phones are withdrawn from the market, the stocked signal lines become useless. A huge loss occurs.

### SUMMARY OF THE INVENTION

The present invention aims to solve the aforesaid problems. The invention provides an earphone jack signal line that has conductive wire which includes a first connector on one end to be inserted into the earphone jack of a mobile phone and a second connector on other end to be connected to a handsfree. The signal line includes at least an earphone circuit and a mike circuit. The earphone jack signal line also has a call detection unit (which may be located in the first connector or second connector, or independently on the conductive wire between the first connector and the second connector). By means of the earphone jack signal line mentioned above to link the mobile phone and handsfree, compatibility of the signal line improves and production cost is lower.

In one aspect, the call detection unit includes a wave detection circuit to detect electromagnetic signals when the mobile phone is in use for conversation to activate operation of the handsfree.

In another aspect, the call detection unit further includes an integration circuit to transform the waveform of sound integration output from the earphone from an audio frequency to a DC signal for comparison, thereby to determine whether the receiving signals are calling signals to avoid generating wrong actions.

The invention can achieve the following effects:
1. The earphone jack signal line can be developed rapidly. Compared with the conventional dedicated signal line connectors, and communication signals and electric contacts of the mobile phone that are restricted, the invention can be developed easily and rapidly. It is progressive and novel. The invention can respond the fast changing mobile phones quickly so that the consumers having new types of mobile phones can acquire new types of signal line rapidly and enjoy the benefits of vehicle handsfrees.
2. The earphone jack signal line of the invention has fewer specifications. Each specification has the same circuit. Unlike the conventional signal lines that have to use dedicated signal line connectors with different corresponding circuits to match different types of mobile phones, inventory of the manufacturers and vendors can be reduced. The concern of idle or overstock caused by obsolete mobile phones is reduced. Production cost is lower.
3. The earphone jack signal line of the invention uses the earphone jack of mobile phones of a universal specification as the connection end. A few specifications can be adapted to a wide variety of mobile phones and handsfrees. The problem of mating one signal line to one type of device occurred to the conventional techniques can be avoided. The incompatibility problem when the device is changed can be prevented.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of a conventional signal line.

FIG. 2 is a schematic view of an embodiment of the invention.

FIG. 3 is a schematic view of a first embodiment of the invention.

FIG. 4 is a schematic view of a second embodiment of the invention.

FIG. 5 is a schematic view of a third embodiment of the invention.

FIG. 6 is a schematic view of an embodiment of the invention for installing the call detection unit.

FIG. 7 is a schematic view of another embodiment of the invention for installing the call detection unit.

FIG. 8 is a schematic view of yet another embodiment of the invention for installing the call detection unit.

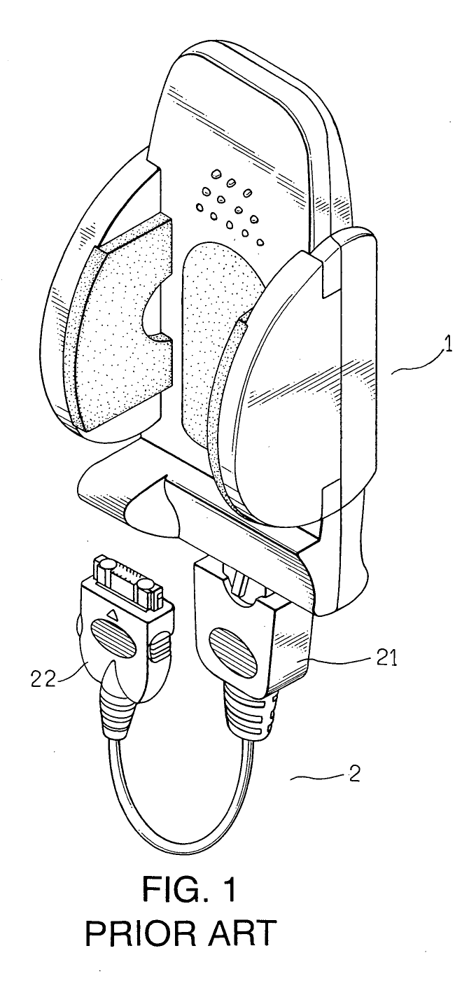

### DESCRIPTION OF THE PREFERRED EMBODIMENTS

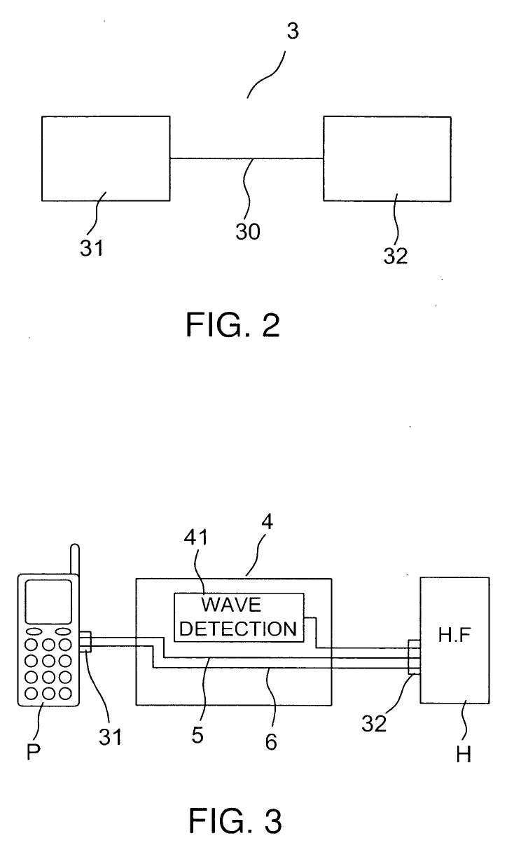

Referring to FIGS. 2 and 3, the earphone jack signal line 3 has a conductive wire 30 with a first connector 31 on one end and a second connector 32 on other end. The earphone jack signal line 3 includes at least an earphone circuit 5 and a mike circuit 6, and a call detection unit 4.

The first connector 31 is to be inserted into an earphone jack of a mobile phone P to get sound signal output or input from the earphone jack.

The second connector 32 is to be inserted into a handsfree H.

The call detection circuit 4 includes a wave detection circuit 41 to detect electromagnetic signals when the mobile phone P is in use for conversation to activate operation of the handsfree H.

The earphone circuit 5 aims to transmit the sound of callers.

The mike circuit 6 aims to transmit the sound of users.

By means of the elements set forth above, when in use, the first connector 31 is connected to the earphone jack of the mobile phone P, and the second connector 32 is connected to the handsfree H. When there is a call to the mobile phone P, the wave detection circuit 41 of the call detection unit 4 gets electromagnetic signals from the base station that communicate with the mobile phone P, and activates operation of the handsfree H. Hence the sound transmitted to the mobile phone P is sent through the earphone jack circuit 5 and mike circuit 6 of the earphone jack signal line 3 to the handsfree H and broadcast. Hence users can do conversation directly with the caller through the handsfree H.

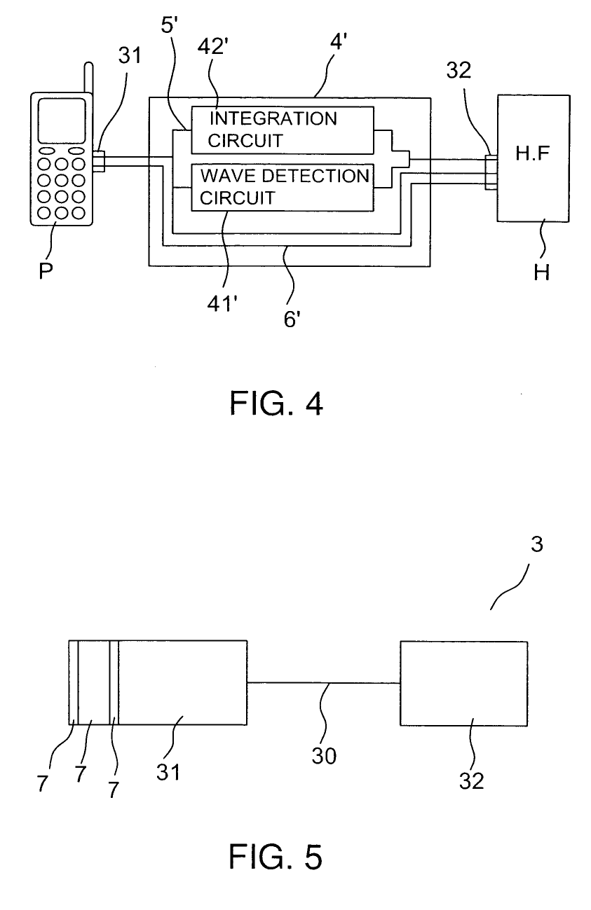

Refer to FIG. 4 for a second embodiment of the invention. To prevent the handsfree H from operating in the wrong way caused by signal exchanged between the base stations of telecommunication providers while the mobile phone P is moved, the call detection unit 4′ further has an integration circuit 42′ which is coupled in parallel with the earphone circuit 5′. Thereby the sound signal output from the earphone jack of the mobile phone P is integrated, and the integrated waveform is transformed from an audio frequency to a DC signal. Hence the sound exceeding a selected ranged can be set to be integrated and treated as the calling signal. Through the integration circuit 42′ and the wave detection circuit 41′, the calling signal can be determined correctly to activate operation of the handsfree H. Hence the calling sound of the mobile phone P can be transmitted through the earphone circuit 5′ and the mike circuit 6′ to the handsfee H, and wrong operation can be prevented.

Refer to FIG. 5 for a third embodiment of the invention. To prevent connection problem caused by different sizes of the earphone jack of the mobile phone P, the first connector 31 may be coupled with a branch connector 7. The branch connector 7 has a first coupler 71 on one end at a size to receive the first connector 31 and a second coupler 72 on another end corresponding to the specification of the earphone jack of the mobile phone P to receive signals from the earphone jack of the mobile phone P.

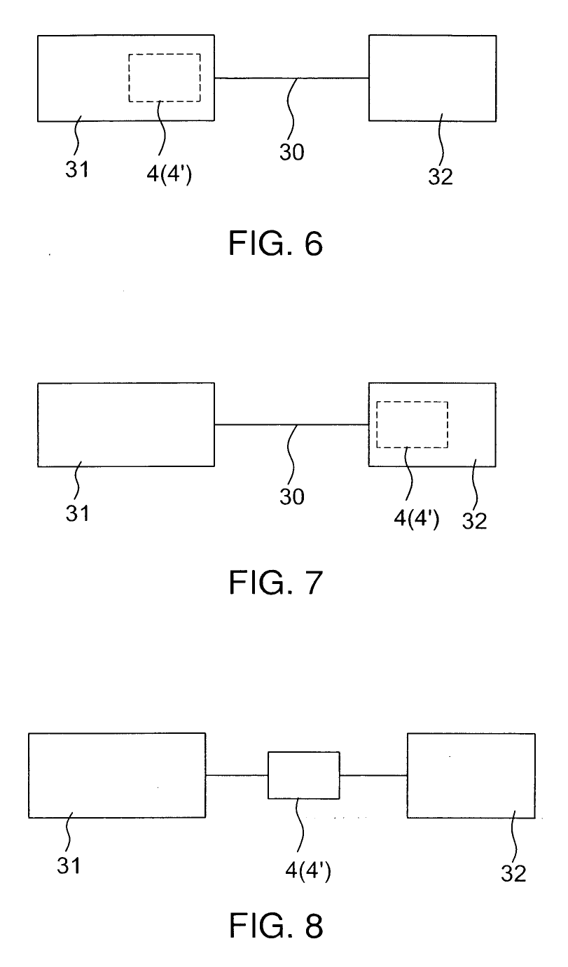

The call detection unit 4 (4′) may be located in the first connector 31 (as shown in FIG. 6), or the second connector 32 (as shown in FIG. 7), or on the conductive wire 30 between the first connector 31 and second connector 32 (as shown in FIG. 8).

In summary, the invention uses the earphone jack of the mobile phone that is rarely changed to function the connection port of the handsfree and the mobile phone. Only a minimum number of earphone jack signal line specifications are needed to connect various types of mobile phones to the handsfree.

While the preferred embodiments of the invention have been set forth for the purpose of disclosure, modifications of the disclosed embodiments of the invention as well as other embodiment thereof may occur to those skilled in the art. Accordingly, the appended claims are intended to cover all embodiments which do not depart from the spirit and scope of the invention.

I claim:

1. An earphone jack signal line comprising a conductive wire which has a first connector on one end and a second connector on other end, and at least an earphone circuit and a mike circuit, and a call detection unit, wherein:
the first connector is connected to an earphone jack of a mobile phone to get output sound of the mobile phone;
the second connector is connected to a handsfree;
the call detection unit includes a wave detection circuit to detect electromagnetic signals while the mobile phone is in use for conversation to determinate conversation conditions of the mobile phone and activate operation of the handsfree;
the earphone circuit is to transmit a caller's sound; and
the mike circuit is to transmit user's sound.

2. The earphone jack signal line of claim 1, wherein the call detection unit further includes an integration circuit to integrate sound signals output by the mobile phone and function cooperatively with the wave detection circuit to determine calling signals and activate operation of the handsfree.

3. The earphone jack signal line of claim 1, wherein the first connector is coupled with a branch connector which has a first coupler on one end to receive the first connector and a second coupler on another end corresponding to the earphone jack of the mobile phone to receive signals.

4. The earphone jack signal line of claim 1, wherein the call detection unit is located in the first connector.

5. The earphone jack signal line of claim 1, wherein the call detection unit is located in the second connector.

6. The earphone jack signal line of claim 1, wherein the call detection unit is located on the conductive wire between the first connector and the second connector.
